(19) United States
(12) Patent Application Publication
(10) Pub. No.: US 2004/0225382 A1
(43) Pub. Date: Nov. 11, 2004

(54) Jerk profile, vector motion control and real time position capture in motion control systems

(76) Inventors: Phil Brown, Portland, OR (US); Nolen Handyside, Hillsboro, OR (US); Randall S. Olsen, Hillsboro, OR (US)

Correspondence Address: DELLETT AND WALTERS, P. O. BOX 2786, PORTLAND, OR, 97208-2786, US

(21) Appl. No.: 10/842,902

(22) Filed: May 10, 2004

Related U.S. Application Data
(60) Provisional application No. 60/469,568, filed on May 9, 2003.

(51) Int. Cl. G05B 13/02

(52) U.S. Cl. 700/28

(57) ABSTRACT

In motion control systems, definable jerk parameters (definable radius of curves on the motion profile) for any particular location on the motion profile are provided. Further, vector mode control capability is provided by employing a ring buffer defining data points across a motion profile, directing movement to a position at a defined velocity. Finally, real time position capture is provided in a motion control system to avoid position determination errors.

### BACKGROUND OF THE INVENTION

This application relates to motion control systems, whereby computerized control of machinery is performed to direct the path of movement of a tool or other device.

In motion control systems, a typical linear motion profile is shown in FIG. 1, where motion starts, reaches a peak velocity, decelerates, and then stops. Each transition goes from, for example, a constant acceleration, to zero acceleration, zero to peak acceleration, etc.

The particular transition points from stop to moving, and moving to different speed, and moving to stop, may have a different particular profile, depending on the particular kinematics of any individual machine. Some devices or applications may have a very quick acceleration profile, for example, but may not be capable of a correspondingly rapid deceleration (or vice versa).

When accelerating from a low velocity to a higher velocity, frictional forces may be higher in on particular change point than at another.

In accordance with the prior art, a “jerk parameter” (which is shown by the radius of the arc at the change point 10 (FIG. 1, 2)) is defined for the entire motion profile. Thus, even though the actual behavior of a given machine may vary depending on the particular motion state and change being performed, the prior art allows only a single overall parameter covering the entire profile. So, the motion control system will not be able to provide accurate or precise operation of the controlled device.

Another issue that can arise in motion control, relates to how to define a motion action. In a typical motion control arrangement, to define a motion action, the user sets a start point, an endpoint, and an acceleration profile. However, it may not always be desirable, convenient or readily apparent to use such a manner of defining motion in every situation.

Also, another issue that arises in motion control relates to position sensing. It is often desired to determine the position of a moving device in response, for example, to a sensor indicating an event has occurred.

Since the device will typically continue to move after the sensor is triggered, any delay in reading the position will introduce an amount of error. Typically, an interrupt is generated by the sensor triggering, and a process is invoked to go read the position of the device. In such an interrupt driven system, a delay of, for examples, 40 microseconds typically will pass before the position is read, in accordance with the prior art. This delay results in less precision in determining the position.

### SUMMARY OF THE INVENTION

In accordance with the invention, an improved motion control system is provided whereby a definable jerk parameter is providable.

It is another object of the invention to provide definable jerk parameters (definable radius of curves on the motion profile) for any particular location on the motion profile.

Yet another system in accordance with an invention herein provides vector mode control capability in a motion control system.

Still another system in accordance with the invention provides real time position capture in a motion control system.

Accordingly, it is an object of the present invention to provide an improved motion control system with improved jerk parameter control.

It is yet another object of the present invention to provide an improved motion control device having vector mode control capability.

A further object of the invention is to provide real time position capture in a motion control system.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a representation of a typical trapezoidal motion profile in accordance with the prior art;

FIG. 2 is a representation of an S-curve motion profile having a constant acceleration rate on both the acceleration and deceleration sides of the profile;

FIG. 3 is an example of asymmetrical S-curve profile;

FIG. 4 is an S-curve velocity profile broken into nine regions;

FIG. 5 is a block diagram of a real time position sensor system; and

FIG. 6 is a block diagram of the vector mode system.

### DETAILED DESCRIPTION

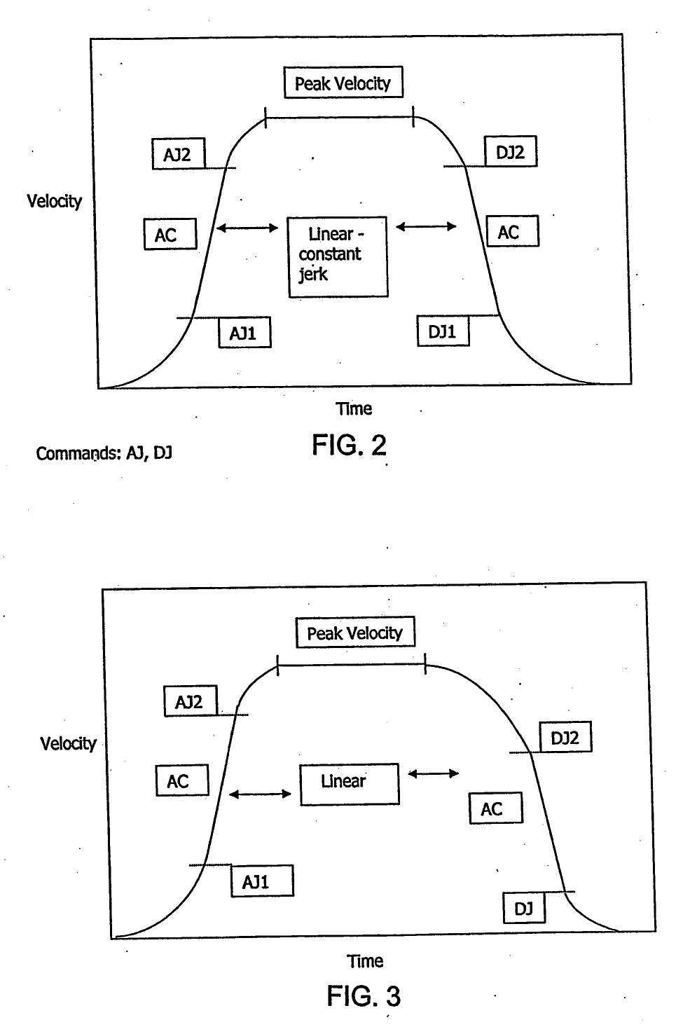

Referring now to FIG. 2, an S-curve acceleration profile is an alternative to the traditional trapezoidal profile that has a constant rate of acceleration, or jerk, on both the acceleration and deceleration sides of the profile.

An S-curve acceleration profile is one that starts with increasing jerk, then transitions to constant jerk, then transitions to decreasing jerk until zero acceleration is reached at the desired velocity. When it is time to start decelerating, the S-curve profile starts increasing jerk and then transitions to constant jerk, and finally transitions to decreasing jerk until zero velocity is reached.

The S-curve profile is not truncated in moves that do not reach full velocity due to moves that are shorter than the acceleration and deceleration distances required to reach full velocity and decelerate to a stop. The S-curve profile is preserved by limiting the velocity on these short moves to a velocity that is sufficiently small to allow the entire profile to be preserved.

In accordance with the invention a command, AJ, for an Accelerating Jerk, defines both the ramp-up and ramp-down portions of an S-curve acceleration profile. The command takes from 0 to 3 parameters. If no parameters are entered, the current AJ parameters are listed. The first parameter, J1, defines the percentage of the constant jerk in the first half of the acceleration. The remaining percentage, 1.0-J1, will be the curved portion of the profile at the start of the acceleration ramp.

This curved portion of the ramp will transition from zero acceleration to the acceleration defined by the AC command.

Range: 0.0<=J1<=1.0

The second parameter, J2, defines the percentage of the constant jerk in the second half of the acceleration. The remaining percentage, 1.0-J2, will be the curved portion of the profile at the end of the acceleration ramp. This portion of the ramp will transition from the acceleration defined by the AC command to zero acceleration. If the second parameter is omitted, it is set equal to the first parameter (J1).

Range: 0.0<=J2<=1.0

The third parameter, J3, defines a radius or stretch factor that increases acceleration time during the non-constant portions of the acceleration.

If the third parameter is omitted, it is set equal to one (1.0).

Range: 0.0<=J1<=10.0

When this command is entered the ramp-down portion of the profile will defined symmetrical to the ramp-up portion of the profile.

### EXAMPLE 1

AJO.5; J2 defaults to 0.5, J3 defaults to 1.0

The lowermost and the uppermost 25% of the ramp will be curved. The lower 25% will be increasing jerk. The upper 25% will be decreasing jerk. The middle 50% will be constant.

### EXAMPLE 2

AJO.5, 0.75; The lower 25% and the upper 12.5% will be curved.

The lower 25% will be increasing jerk. The upper 12.5% will be decreasing jerk. The middle 62.5% will be constant.

DJ Decelerating Jerk

This command can be used to produce asymmetrical S-curve profiles.

The command is analogous to the AJ command. It defines equivalent parameters for the falling edge or ramp-down portion of an S-curve acceleration profile. Parameter one defines the lower portion of the ramp and parameter two defines the upper portion of the ramp, similar to the AJ command parameters one and two, respectively. If parameter two is omitted, it is set equal to parameter one by default.

Parameter three defines a radius or stretch factor that increases acceleration time during the non-constant portions of the acceleration.

If parameter three is omitted it is set to 1.0 by default.

The range of valid values for DJ command parameters is equivalent to the ranges for the AJ command parameters.

The parameters entered with the DJ command override the AJ parameters for the falling edge of the profile, therefore this command must be entered AFTER any AJ command to produce asymmetrical profiles.

If no parameters are entered with the DJ command then the currently defined DJ parameters are listed.

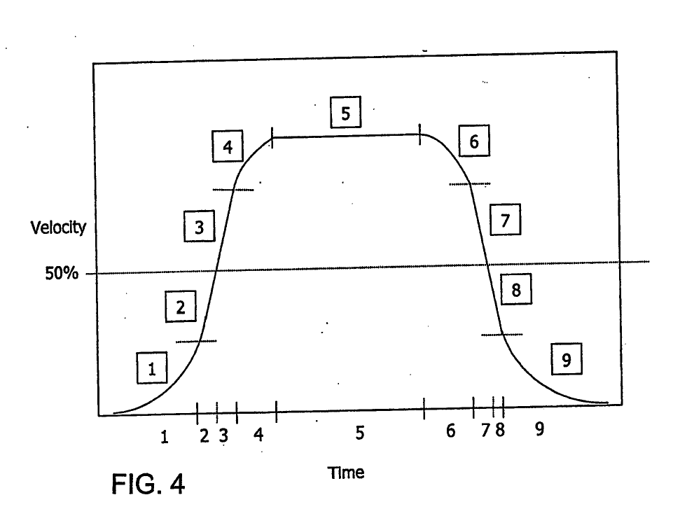

FIG. 3 is an example of asymmetrical S-curve profile. In FIG. 4, the S-curve velocity profile is broken into nine regions. What follows is a description of the nine regions and how they are defined by the AJ and DJ command parameters.

AJ command parameter one determines the length of region 2 by specifying the percentage on constant jerk (linear acceleration) below the fifty percent velocity line. Region 1 is also defined indirectly by parameter 1 and is the remainder of the profile below the fifty percent velocity line.

AJ command parameter two determines the length of region 3 by specifying the percentage of constant jerk above the fifty percent velocity line. Region 4 is also defined indirectly by the parameter 2 and is the remainder of the profile above the fifty percent velocity line and below the maximum velocity (region 5).

AJ command parameter three can be used to “stretch” regions 1 and 4 in the time dimension.

If no DJ command is entered, then regions 6, 7, 8, and 9 are symmetrical with regions 4, 3, 2, and 1 respectively. If a DJ command is entered then regions 6, 7, 8 and 9 can be specified independently of regions 4, 3, 2, and 1, thus producing an asymmetrical profile.

DJ command parameter one directly determines the length of region 8 by specifying the percentage of constant jerk below the fifty percent velocity line. Region 9 is also defined indirectly by parameter 1 and is the remainder of the profile below the fifty percent line.

DJ command parameter two directly determines the length of region 7 by specifying the percentage of constant jerk above the fifty percent velocity line. Region 6 is also defined indirectly by parameter two and is the remainder of the profile above the fifty percent line and below the maximum velocity (region 5).

DJ command parameter three can be used to “stretch” regions 6 and 9 in the time dimension.

Note the following in connection with the above description:

1. Parameters are separated by commas.

2. The command “AJ1.0,1.0;” is equivalent to a symmetrical S-curve profile, where the transitions in acceleration and deceleration are uniform.

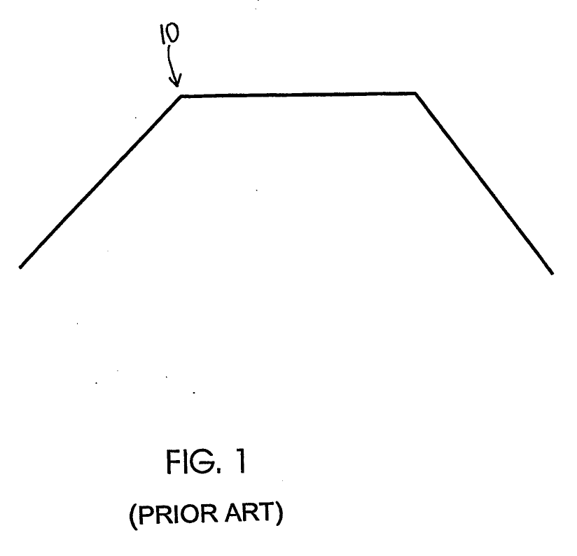

3. The command “AJ0,0;” is equivalent to the linear ramp type (see FIG. 1).

4. Entering an AJ command with parameters automatically sets all DJ parameters equal to the AJ parameters, producing a symmetrical profile.

5. The “?RT” command returns which profile is defined for any given axis and the “SS” command is used to select the specific defined S-curve ramp type.

Thus, in accordance with the invention, the jerk profile for any particular point on a motion profile is definable, whereby precise control is obtainable. The system may be implemented by use of a microprocessor or controller that is adapted to control a motion device in accordance with the above information.

While in accordance with the prior art, motion control commands have heretofore been defined by setting a velocity and an endpoint, where velocity is defined in the number of update cycles of the controller, in accordance with the invention, a table in memory is built, in the form of a ring buffer. Into the buffer are defined data points across a motion profile, directing movement to a position at a defined velocity. Motion thus continues at the velocity in the defined direction until other data is provided giving another motion command. This allows creation of any type of motion profile in real time.

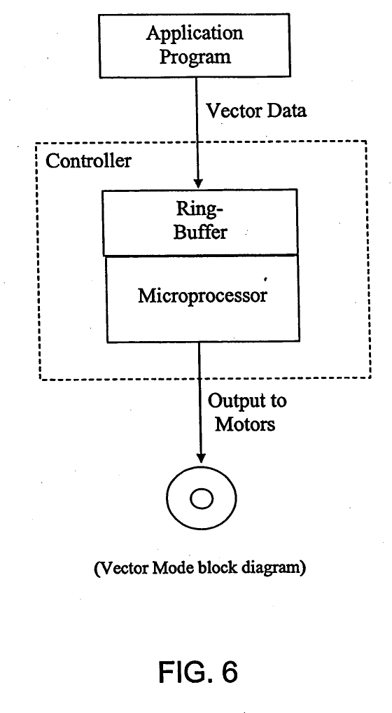

In the ring buffer, a particular data point will indicate which axes are to be controlled (one or many axes can be controlled in this manner). FIG. 6 illustrates a block diagram of the vector mode employing a ring buffer. In this configuration, an application program supplies vector data to a ring buffer, which is supplied to a microprocessor. The microprocessor provides output to motors for control thereof.

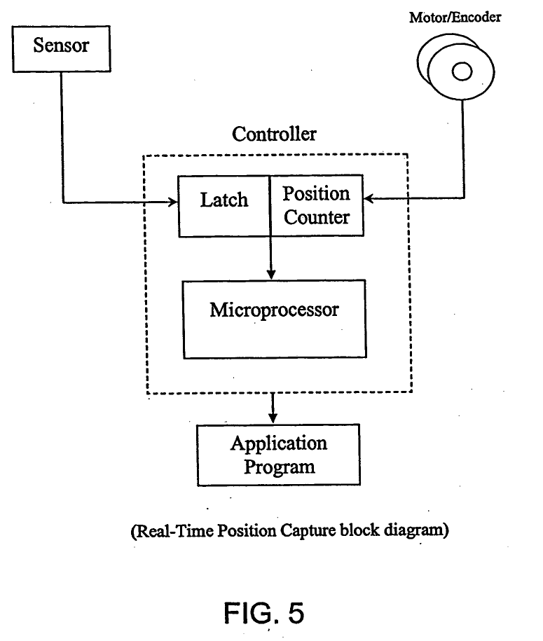

As noted hereinabove in the background, since a moving device will typically continue to move after a sensor is triggered, any delay in reading the position of the device after the sensor is triggered, will introduce an amount of error. In accordance with an aspect of the invention, this undesirable result is overcome, eliminating this delay, by providing a hardware latch that, in connection with the sensor being triggered, will latch the position data at the time the sensor triggers, taking a snapshot of the position data. Then, the latched data can be retrieved without having to be concerned about any delay caused by microprocessor response time to an interrupt indicating that the sensor has triggered. Referring to FIG. 5, it may be observed that input from the sensor is supplied to a latch, while input from a motor/encoder is supplied to a position counter. The activation of the sensor causes the latch to read the position counter showing the position of the motor/encoder at that time. Then, later, the microprocessor can retrieve the position from the latch, under direction, for example, of the application program.

While plural embodiments of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1. A motion control jerk profile system, comprising:
a controller adapted to provide a definable accelerating jerk profile for ramp-up and ramp-down portions of an acceleration profile.

2. The motion control system according to claim 1, wherein said controller is further adapted to provide an adjustable constant jerk.

3. The system according to claim 1, wherein said controller is further adapted to provide an adjustable stretch factor that adjusts acceleration time during a non-constant portion of acceleration.

4. A method of providing a motion control system, comprising:
providing a definable accelerating jerk profile to define ramp-up and ramp-down properties of an acceleration profile.

5. The method according to claim 4, further comprising providing an adjustable constant jerk.

6. The method according to claim 4, further comprising providing an adjustable stretch factor for adjusting acceleration time during a non-constant portion of acceleration.

7. A motion control vector control system, comprising:
a microprocessor; and
a ring buffer providing input to said microprocessor of ones of data points across a motion profile for directing movement to a position at a defined velocity, wherein said microprocessor controls an output device based thereon.

8. The motion control system according to claim 8, wherein a selected one of said data points comprises a indication of one or more axes to be controlled.

9. A motion control system, comprising:
a positionable device;
a latch; and
a sensor,
wherein said latch is responsive to activation of said sensor to latch a location position information of said positionable device when said sensor is activated, thereby storing the real time position of said positionable device at a time of activation of said sensor, for later access.

10. The system according to claim 9, wherein said positionable device is an encoder.

11. The system according to claim 9, wherein said encoder is a motor encoder.

12. The system according to claim 9, further comprising a microprocessor, wherein said microprocessor accesses said latch later in time after latching of said location position information for processing thereof.
